(19) United States
(12) Patent Application Publication
(10) Pub. No.: US 2017/0280447 A1
(43) Pub. Date: Sep. 28, 2017

(54) USER APPARATUS AND BUFFER CONTROL METHOD

(71) Applicant: NTT DOCOMO, INC., Tokyo (JP)

(72) Inventors: Tooru Uchino, Tokyo (JP); Kunihiko Teshima, Tokyo (JP); Kazuki Takeda, Tokyo (JP); Hideaki Takahashi, Tokyo (JP)

(73) Assignee: NTT DOCOMO, INC., Tokyo (JP)

(21) Appl. No.: 15/510,924

(22) PCT Filed: Feb. 17, 2016
(86) PCT No.: PCT/JP2016/054534

§ 371 Date: Mar. 13, 2017

(30) Foreign Application Priority Data
Feb. 20, 2015 (JP) 2015-032341

(51) Int. Cl. H04W 72/04; H04W 16/32; H04W 28/02; H04L 5/00

(52) U.S. Cl. CPC H04W 72/0446; H04L 5/0055; H04W 16/32; H04W 28/02; H04W 88/02

(57) ABSTRACT

A user apparatus communicates with a base station in a mobile communication system which includes cells including a first cell and a second cell which uses a TTI different from that of the first cell, includes a reception unit with a buffer for, in the case where decoding of downlink data received from the base station has failed, storing the downlink data in the buffer, and combining the downlink data stored in the buffer and retransmitted data transmitted from the base station based on acknowledgment information for the downlink data, and decoding the combined result; and a transmission unit for transmitting the acknowledgment information for the downlink data to the base station. The reception unit includes a buffer control unit for dividing the buffer with a dividing number based on the TTIs of the first and second cells, and storing the downlink data in divided areas of the buffer.

### BACKGROUND OF THE INVENTION

1. Field of the Invention

The present invention relates to a HARQ control method for downlink data of a user apparatus in a mobile communication system including LTE.

2. Description of the Related Art

Carrier aggregation (CA) is adopted in an LTE system. In carrier aggregation, communications are performed by having a predetermined bandwidth as a basic unit and using a plurality of carriers at the same time. (Non-Patent Document 1) A carrier as a basic unit in carrier aggregation is referred to as a component carrier (CC).

When CA is performed, a primary cell (PCell) with high reliability for securing connectivity and a secondary cell (SCell) are configured for a user apparatus UE. The user apparatus UE is first connected to a PCell, and, if necessary, a SCell can be added. The PCell is similar to a single cell which supports radio link monitoring (RLM) and semi-persistent scheduling (SPS), etc.

Adding and removing of SCell is performed by a radio resource control (RRC) signaling. Right after a SCell is configured for the user apparatus UE, the SCell is in a deactivated state. The SCell becomes available for communications (capable of scheduling) for the first time after it is activated.

In the user apparatus UE and a base station eNB of the LTE system, hybrid ARQ (HARQ) control is performed by HARQ entities in media access control (MAC) layer (Non-Patent Document 2). For example, in the HARQ control for downlink data of the user apparatus UE, ACK is returned to the base station eNB in the case where decoding of the downlink data (TB: transport block) is successful, and NACK is returned to the base station eNB in the case where the decoding is failed. HARQ acknowledgments (ACK/NACK) are transmitted via a physical uplink control channel (PUCCH) of a predetermined UL resource at a predetermined timing after receiving the downlink data (e.g., after four sub-frames) (Non-Patent Document 3).

In existing LTE, as a radio frame structure, it is defined that 1 radio frame is 10 ms, 1 subframe is 1 ms, 1 slot is 0.5 ms (Non-Patent Document 4). One subframe corresponds to a transmission time interval (TTI) which is a minimum unit of scheduling. In other words, for each subframe, a resource block (RB) is allocated for a user apparatus (UE) selected by the scheduling of the base station eNB. One RB includes, for example, 12 subcarriers in frequency direction (OFDM subcarriers) and 7 symbols in time direction (OFDM symbols).

It should be noted that in the 3rd generation partnership project (3GPP), it is planned that the standardization of the fifth generation wireless technology (hereinafter, referred to as “5G”) will be started from Release 14 (Rel-14) or later. In the 5G, it has been investigated that one TTI is shortened to be 0.1 ms in order to reduce a wireless communication delay.

Further, as a form of 5G operation, an operation has been investigated in which CA is performed by having an LTE cell as a base and having a 5G cell overlaid. An example of the above operation form is illustrated in FIG. 1. As illustrated in FIG. 1, an LTE cell as a macro cell is formed by a base station eNB, a 5G cell as a small cell is formed by, for example, remote radio equipment (RRE) extended from the base station eNB, and a user apparatus UE performs high-throughput communications by using CA according to the LTE cell and the 5G cell.

In existing LTE, it is defined that, in CA in which two or more serving cells are configured, ACK/NACK for DL is fed back only in the PCell (Non-Patent Document 3). More specifically, the user apparatus UE feeds back ACK/NACK for DLs in serving cells included in CA by using a PUCCH resource in the PCell. With the above operation, DL CA becomes available.

It can be assumed that the control described above will be used for CA for which an LTE cell and a 5G cell are configured.

In general, it is difficult to implement UL CA in the user apparatus UE because of inter-modulation (IM), and it is understood that it will still be difficult to implement UL CA at the time of 5G introduction. Therefore, it is assumed that, in order to avoid 5G terminal release delay, DL CA having a 5G cell as a SCell including downlink CC will be supported. FIG. 2 illustrates an example of an ACK/NACK feedback in LTE-5G CA based on the above assumption. As illustrated in FIG. 2, in the LTE-5G CA, the user apparatus UE receives downlink data via an SCell and a PCell, and transmits an ACK/NACK for the downlink data to the base station eNB via PUCCH of the LTE (PCell).

In the LTE-5G CA described above, a case will be considered in which a TTI length of the 5G is a tenth of the TTI length of the LTE as illustrated in FIG. 3. In this case, as illustrated in FIG. 3, it is necessary that an ACK/NACK for the DL of the LTE (1 LTE-TTI) and an ACK/NACK of the DL of the 5G (10 5G-TTIs) should be fed back to the base station eNB in 1 LTE UL subframe.

As described above, in HARQ, retransmission, etc., are controlled by ACK/NACK transmission. In HARQ, in the case where the user apparatus UE fails to decode the received data (in the case where the received data includes an error), the user apparatus UE holds the received data, combines data retransmitted from the base station eNB with the held data, and decodes the combined data. With the above operation, strong error resistance is obtained. A storage unit (memory area) for holding the data is referred to as a soft buffer.

The soft buffer in the user apparatus UE has a predetermined size according to the capability of the user apparatus UE. In the related art, the soft buffer is divided evenly by the number of cells (CC number), and received data items (DL MAC PDU, TB) are stored in the corresponding evenly divided areas.

However, in LTE-5G CA, the number of the data items the user apparatus UE receives during a period of an LTE-TTI is increased, and thus, there is a possibility that the soft buffer becomes insufficient if it is evenly divided by the number of cells as before. In the case where the soft buffer is insufficient, there is a possibility that the base station eNB is unable to properly perform the scheduling, and that a delay occurs.

In view of the above, an object of the present invention is to provide a technique in which it is possible, in a mobile communication system which supports carrier aggregation including a plurality of cells with different TTI lengths, to appropriately divide a buffer used for controlling retransmission of downlink data in a user apparatus which performs the carrier aggregation.

### CITATION LIST

### Non-Patent Document

[Non-Patent Document 1] 3GPP TS 36.300 V12.4.0 (2014-12)
[Non-Patent Document 2] 3GPP TS 36.321 V12.4.0 (2014-12)
[Non-Patent Document 3] 3GPP TS 36.213 V12.4.0 (2014-12)
[Non-Patent Document 4] 3GPP TS 36.211 V12.4.0 (2014-12)

### SUMMARY OF THE INVENTION

According to an embodiment of the present invention, a user apparatus is provided. The user apparatus performs communications with a base station in a mobile communication system which includes a plurality of cells including a first cell and a second cell which uses a TTI length different from a TTI length of the first cell.

The user apparatus includes a reception unit having a buffer configured to, in the case where decoding of downlink data received from the base station has failed, store the downlink data in the buffer, and combine the downlink data stored in the buffer and data retransmitted from the base station based on acknowledgment information for the downlink data, and decode the combined result; and a transmission unit configured to transmit the acknowledgment information for the downlink data to the base station. The reception unit includes a buffer control unit configured to divide the buffer with a dividing number based on the TTI length of the first cell and the TTI length of the second cell, and store the downlink data in a divided area of the buffer.

Further, according to an embodiment of the present invention, a buffer control method is provided. The buffer control method is performed by a user apparatus which performs communications with a base station in a mobile communication system which includes a plurality of cells including a first cell and a second cell which uses a TTI length different from a TTI length of the first cell.

The buffer control method includes, in the case where decoding of downlink data received from the base station has failed, storing the downlink data in a buffer included in the user apparatus; combining the downlink data stored in the buffer and data retransmitted from the base station based on acknowledgment information for the downlink data; decoding the combined result; and transmitting the acknowledgment information for the downlink data to the base station. In the receiving, the user apparatus divides the buffer with a dividing number based on the TTI length of the first cell and the TTI length of the second cell, and stores the downlink data in a divided area of the buffer.

According to an embodiment of the present invention, it is possible, in a mobile communication system which supports carrier aggregation including a plurality of cells with different TTI lengths, to appropriately divide a buffer used for controlling retransmission of downlink data in a user apparatus which performs the carrier aggregation.

### BRIEF DESCRIPTION OF THE DRAWINGS

FIG. 1 is a drawing illustrating an example of a case in which an LTE cell is used as a macro cell and 5G cell is used as a small cell.

FIG. 2 is a drawing illustrating a feedback of ACK/NACK.

FIG. 3 is a drawing illustrating a problem.

FIG. 4 is a diagram of a system according to an embodiment of the present invention.

FIG. 5 is a drawing illustrating a basic operation of the system.

FIG. 6 is a diagram of a user apparatus UE according to an embodiment.

FIG. 7 is a hardware configuration diagram of the user apparatus UE.

FIG. 8 is a diagram of a base station eNB according to an embodiment.

FIG. 9 is a hardware configuration diagram of the base station eNB.

FIG. 10 is a drawing illustrating an example of an overall configuration of a DL signal reception unit 102.

FIG. 11 is a drawing illustrating a procedure for a soft buffer division.

FIG. 12 is a drawing illustrating an example of a soft buffer division.

FIG. 13 is a drawing illustrating another procedure for the soft buffer division.

FIG. 14 is a drawing illustrating an ACK/NACK bundling.

FIG. 15 is a drawing illustrating an example of a process sequence in an ACK/NACK transmission method example 1.

FIG. 16 is a drawing illustrating an example of a bundling process.

FIG. 17 is a drawing illustrating an example of a PUCCH resource in the ACK/NACK bundling.

FIG. 18 is a drawing illustrating an example of an ACK/NACK transmission in 16CC CA.

FIG. 19 is a drawing illustrating an example of a process sequence in an ACK/NACK transmission method example 2.

FIG. 20 is a drawing illustrating an ACK/NACK transmission for data reception in 5G.

### DETAILED DESCRIPTION OF THE PREFERRED EMBODIMENTS

In the following, referring to the drawings, embodiments of the present invention will be described. It should be noted that the embodiments described below are merely examples and the embodiments to which the present invention is applied are not limited to the following embodiments.

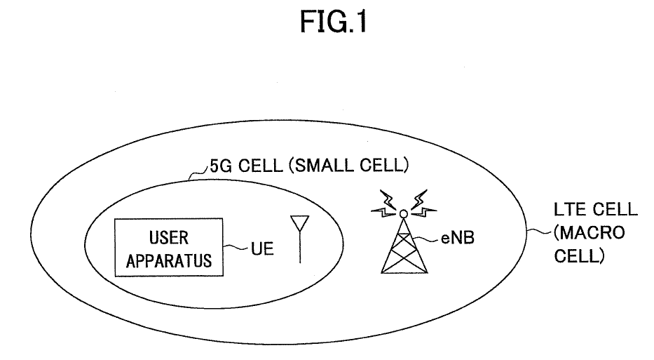

In an embodiment, a mobile communication system is provided which is capable of performing carrier aggregation (CA) for which a cell of LTE and a cell of 5G as illustrated in, for example, FIG. 1 are configured. However, application of the present invention is not limited to LTE and 5G. The present invention can be applied to other radio access technologies (RAT) which are capable of carrier aggregation.

Further, a “cell” which is configured for CA is a cell in which the user apparatus UE resides, and may be referred to as a serving cell. As an example, the “cell” which is configured for CA includes only downlink CC, or includes downlink CC and uplink CC. Further, it is assumed that releases of 3GPP specifications of “LTE” in this application specification and claims may be, but are not limited to, any release in which CA is introduced.

(Overall System Configuration)

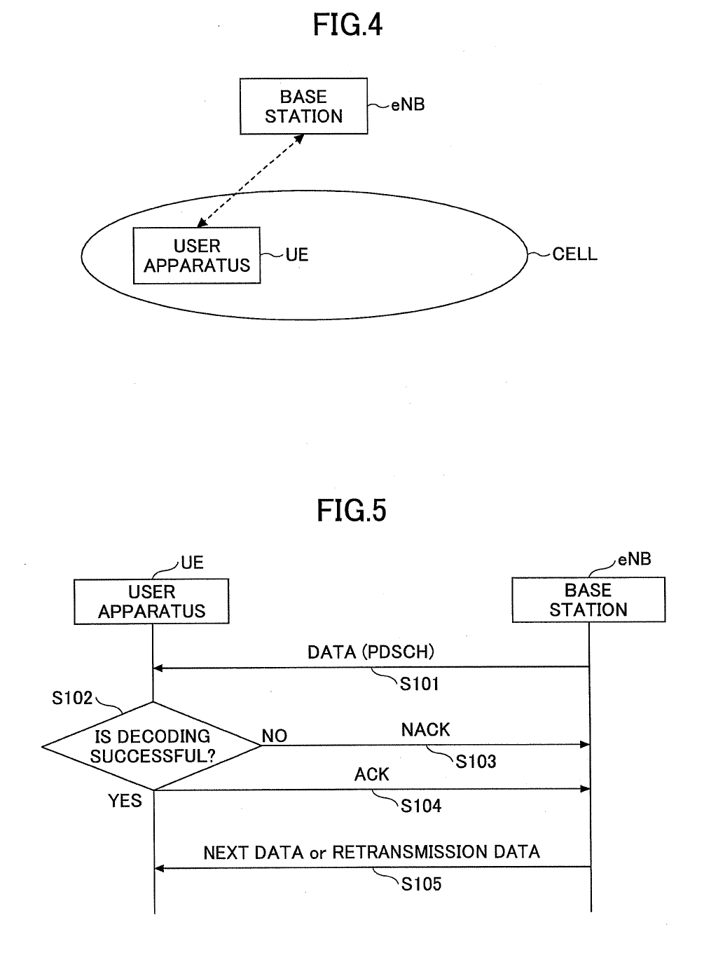

FIG. 4 illustrates a diagram of a communication system according to an embodiment of the present invention. As illustrated in FIG. 4, the communication system is a mobile communication system including a base station eNB and a user apparatus UE. It is possible for the base station eNB and the user apparatus UE to perform LTE-5G CA communications. In FIG. 4, for the sake of convenience, a single base station eNB and a single user apparatus UE are illustrated. Multiple base stations eNB and multiple user apparatuses UE may exist.

In LTE-5G CA, a TTI length is 1 ms in a LTE cell, and 0.1 ms in 5G cell. It should be noted that “TTI length in a 5G cell=0.1 ms” is only an example. The TTI length in a 5G cell may be another TTI length shorter than the TTI length in LTE. In the following, in order to distinguish between a “subframe” in LTE and a “subframe” in 5G, the subframe in LTE (=TTI length of LTE) is referred to as “LTE subframe” and the subframe in 5G (=TTI length of 5G) is referred to as “5G subframe”. It should be noted that, in the case where it is not necessary to distinguish LTE/5G, in the case where it is obvious which of LTE/5G is referred to, etc., “subframe” may be used.

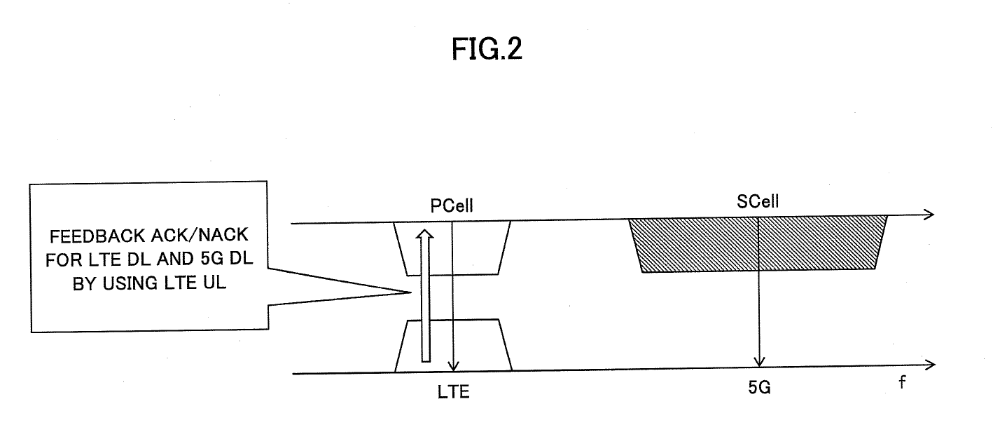

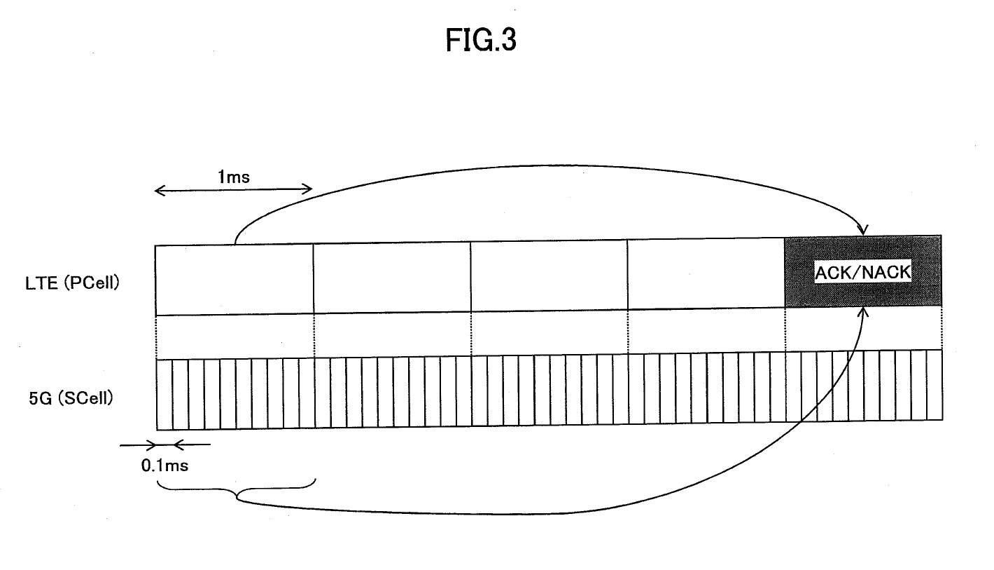

Further, in an embodiment, when LTE-5G CA is configured for the user apparatus UE, as illustrated in FIG. 2, a PCell is configured with LTE, a SCell is configured with 5G, and ACK/NACK for downlink data is transmitted to the base station eNB via PUCCH of the PCell. It should be noted that, in the case where a SCell capable of transmitting PUCCH is configured as an LTE cell, the ACK/NACK may be transmitted by using PUCCH of the SCell.

In an example of FIG. 4, a single cell is indicated for the sake of convenience. When CA is configured, multiple cells exist. Further, for example, one or more RREs (remote radio equipment) connected to the base station eNB via an optical fiber, etc., may be included at a location away from the eNB. In a configuration in which the RRE is included, for example, a macro cell is formed by a PCell, a small cell is formed by a SCell as a subordinate of the RRE, and a user apparatus UE residing in the small cell performs high-throughput communications by using CA.

<Basic Operation Example>

Referring to FIG. 5, an example of a basic operation of a communication system according to an embodiment will be described. As a prerequisite of an operation illustrated in FIG. 5, it is assumed that CA has been configured with an LTE PCell and a 5G SCell for the base station eNB and the user apparatus UE.

In step S101 of FIG. 5, the user apparatus UE receives DL data (data of transport block (TB)) via the SCell. Here, for example, during a period of 1 LTE subframe, the DL data is received as multiple 5G subframes. Further, depending on the transmission mode, 1 or 2 TB (signals) are received in 1 5G subframe. In the following, it is assumed that, as an example, unless otherwise specified, 1 TB is received in 1 5G subframe.

In step S102, the user apparatus UE determines whether decoding of the DL data items are successful. As a basic operation, the user apparatus UE generates an ACK of the DL data item if decoding of the DL data item is successful, generates a NACK of the DL data item if decoding of the DL data item has failed, and transmits the ACK/NACK to the base station eNB via PUCCH of the PCell (step S103 or S104). Further, in the case where the decoding of the DL data item has failed, the data item is stored in a soft buffer.

It should be noted that, in an embodiment, “decoding is successful” means that, for example, data obtained by the decoding has no error (including a case where the number of errors is equal to or less than a predetermined number), and “decoding has failed” means that, for example, data obtained by the decoding has an error (including a case where the number of errors is equal to or greater than a predetermined number).

The base station eNB transmits the next DL data item in the case where an ACK is received for the transmitted DL data item, and retransmits the DL data item in the case where a NACK is received for the transmitted DL data item (step S105). When retransmitted data item is received, the user apparatus UE decodes the retransmitted data combined with the data stored in the soft buffer.

In an embodiment, the soft buffer is divided by taking into account the number of 5G-TTIs included in an LTE-TTI. The details of the dividing method will be described later. In an embodiment, the dividing number is calculated based on the LTE-TTI because HARQ timings including ACK/NACK transmission, etc., are specified based on the LTE-TTI in an embodiment.

(Apparatus Structure Example)

Next, main structures of the user apparatus UE and the base station eNB which are capable of performing all processes described in an embodiment (including ACK/NACK transmission methods 1 and 2) will be described.

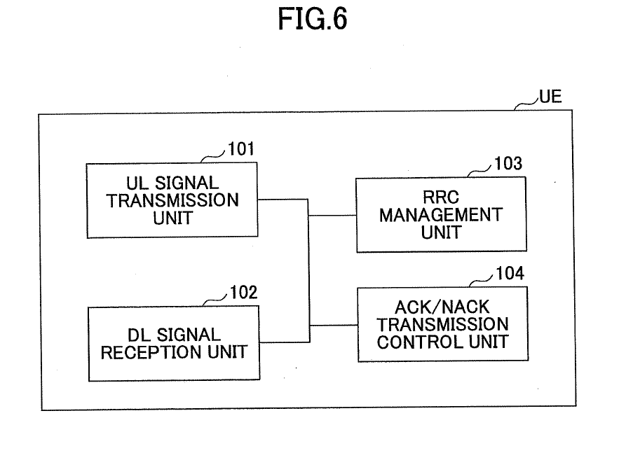

FIG. 6 illustrates a functional structure diagram of the user apparatus UE according to an embodiment. As illustrated in FIG. 6, the user apparatus UE includes a UL signal transmission unit 101, a DL signal reception unit 102, a RRC management unit 103, and an ACK/NACK transmission control unit 104. FIG. 6 illustrates functional units of the user apparatus UE especially related to an embodiment only, and thus, the user apparatus UE further includes at least functions for performing operations according to LTE (not shown in the figure). Further, the functional structure illustrated in FIG. 6 is only an example. Functional classification and names of functional units are not limited to those illustrated in FIG. 6 as long as operations related to an embodiment can be performed.

The UL signal transmission unit 101 includes a function for wirelessly transmitting various kinds of physical layer signals generated from an upper layer signal that the user apparatus UE should transmit. The DL signal reception unit 102 includes a function for wirelessly receiving various kinds of signals from the base station eNB, and obtaining upper layer signals from the received physical layer signals. Each of the UL signal transmission unit 101 and the DL signal reception unit 102 includes a function for performing CA in which multiple CCs are bundled for communications. Further, the multiple CCs may include CCs of different RATs such as LTE and 5G. As an example, as illustrated in FIG. 2, etc., it is possible for the user apparatus UE to perform CA by having LTE as a PCell and 5G as a SCell.

In an embodiment, basically similar to LTE, processes of layer 1 (PHY), layer 2 (MAC, RLC, PDCP), layer 3 (RRC), etc., are performed in 5G. Each of the UL signal transmission unit 101 and the DL signal reception unit 102 includes a packet buffer, and performs processes of layer 1 (PHY) and layer 2 (MAC, RLC, PDCP). However, the functional structure is not limited to the above.

The RRC management unit 103 includes a function for transmitting and receiving an RRC signal to and from the base station eNB, and performing processes of configuring/changing/managing CA information, changing configuration, etc. Further, the RRC management unit 103 may include a function of configuring/managing bundling time and space in an ACK/NACK transmission method example 1 which will be described later, and a function of configuring/managing a PUCCH format in an ACK/NACK transmission method example 2 and association information between ACK/NACK resources of CC and 5G subframe numbers, etc. Further, the RRC management unit 103 may include a function for transmitting capability information including a soft buffer size to the base station eNB via the UL signal transmission unit 101. It should be noted that the above functions may be included in a function unit other than the RRC management unit 103 in the user apparatus UE.

The ACK/NACK transmission control unit 104 controls ACK/NACK transmission in the ACK/NACK transmission method examples 1 and 2. For example, in the ACK/NACK transmission method example 1, the ACK/NACK transmission control unit 104 bundles ACK/NACKs of DL data items generated by the DL signal reception unit 102 according to bundling configuration information transmitted from the base station eNB, and causes the UL signal transmission unit 101 to transmit the bundled ACK/NACKs via PUCCH of PCell.

Further, in the ACK/NACK transmission method example 2, the ACK/NACK transmission control unit 104 causes the UL signal transmission unit 101 to transmit ACK/NACKs of DL data items generated by the DL signal reception unit 102 by using ACK/NACK resources according to the association configuration information transmitted from the base station eNB. It should be noted that the ACK/NACK transmission control unit 104 may be included in the UL signal transmission unit 101.

The structure of the user apparatus illustrated in FIG. 6 may be entirely realized by hardware circuit (e.g., one or more IC chips), or may be partially realized by hardware circuit and the remaining part may be realized by a CPU and programs.

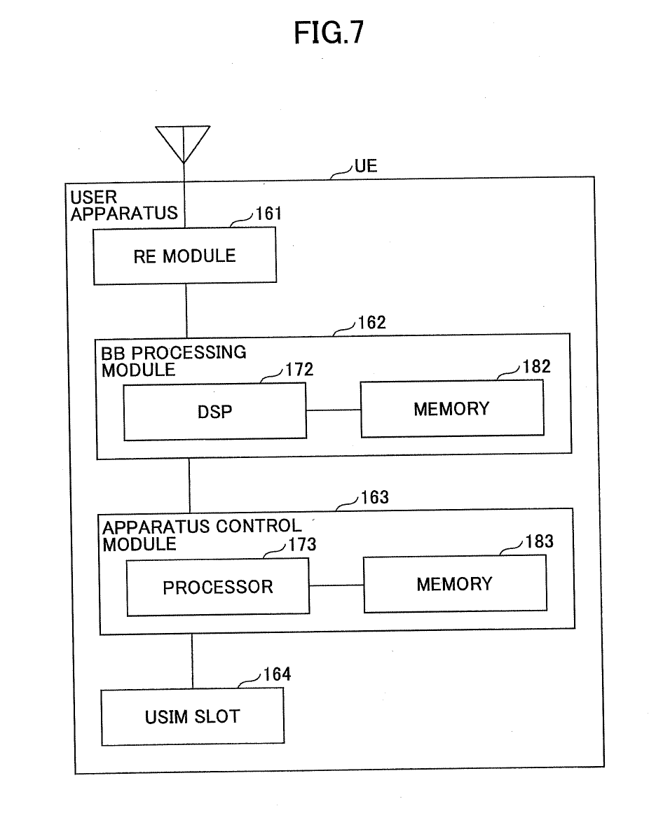

FIG. 7 is a drawing illustrating an example of a hardware (HW) configuration of the user apparatus UE. FIG. 7 illustrates a structure closer to an implementation example compared to FIG. 6. As illustrated in FIG. 7, the user apparatus UE includes a radio equipment (RE) module 161 for performing a process related to a wireless signal, a base band (BB) processing module 162 for performing a baseband signal process, an apparatus control module 163 for performing a process of upper layers, etc., and a USIM slot 164 which is an interface for accessing a USIM card.

The RE module 161 generates a radio signal to be transmitted from an antenna by performing digital-to-analog (D/A) conversion, modulation, frequency conversion, power amplification, etc., for a digital baseband signal received from the BB processing module 162. Further, the RE module 161 generates a digital baseband signal by performing frequency conversion, analog to digital (A/D) conversion, demodulation, etc., for a received radio signal, and transmits the generated signal to the BB processing module 162. The RE module 161 has, for example, functions of a physical layer, etc., in the UL signal transmission unit 101 and the DL signal reception unit 102 illustrated in FIG. 6.

The BB processing module 162 performs a process of converting bidirectionally between an IP packet and a digital baseband signal. Digital signal processor (DSP) 172 is a processor for performing a signal process in the BB processing module 162. A memory 182 is used as a work area of the DSP 172. The BB processing module 162 has, for example, functions of a layer 2, etc., in the UL signal transmission unit 101 and the DL signal reception unit 102 illustrated in FIG. 6, and includes the RRC management unit 103 and the ACK/NACK transmission control unit 104. It should be noted that all or a part of functions of the RRC management unit 103 and the ACK/NACK transmission control unit 104 may be included in the apparatus control module 163.

The apparatus control module 163 performs an IP layer protocol process, processes of various types of applications, etc. A processor 173 performs a process performed by the apparatus control module 163. A memory 183 is used as a work area of the processor 173. Further, the processor 173 reads/writes data from/to the USIM via the USIM slot 164.

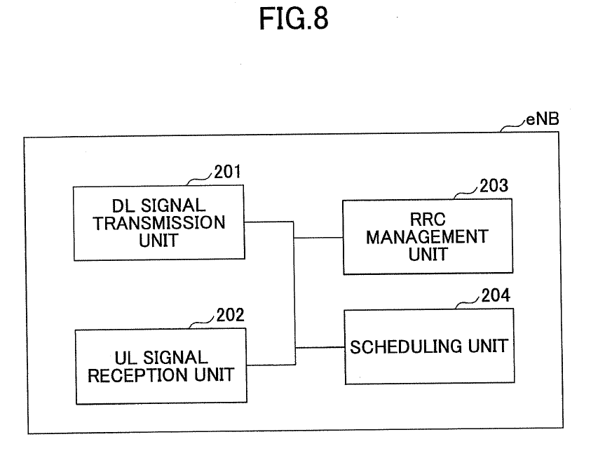

FIG. 8 illustrates a functional configuration diagram of the base station eNB according to an embodiment. As illustrated in FIG. 8, the base station eNB includes a DL signal transmission unit 201, a UL signal reception unit 202, a RRC management unit 203, and a scheduling unit 204. FIG. 8 illustrates functional units of the base station eNB especially related to an embodiment only, and thus, the base station eNB further includes at least functions for performing operations according to LTE (not shown in the figure). Further, a functional structure illustrated in FIG. 8 is only an example. Functional classification and names of functional units are not limited to as illustrated in FIG. 8 as long as operations related to an embodiment can be performed.

The DL signal transmission unit 201 includes a function for wirelessly transmitting various kinds of physical layer signals generated from an upper layer signal which should be transmitted from the base station eNB. The UL signal reception unit 202 includes a function for wirelessly receiving various kinds of signals from the user apparatuses UE, and obtaining upper layer signals from the received physical layer signals. Each of the DL signal transmission unit 201 and the UL signal reception unit 202 includes a function for performing CA for which multiple CCs are bundled for communication.

Further, the multiple CCs may include CCs of different RATs such as LTE and 5G. As an example, as illustrated in FIG. 2, etc., it is possible for the base station eNB to perform CA by having LTE as a PCell and 5G as a SCell. Further, similar to the RRE, the DL signal transmission unit 201 and the UL signal reception unit 202 may be a radio communication unit located remotely from the body (control unit) of the base station eNB.

It is assumed, but not limited to, that the DL signal transmission unit 201 and the UP signal reception unit 202 respectively have packet buffers and perform processes of layer 1 (PHY) and layer 2 (MAC, RLC, PDCP).

The RRC management unit 203 includes a function for transmitting and receiving an RRC signal to and from the user apparatus UE, and performing processes of configuring/changing/managing CA, configuration change, etc. The RRC management unit 203 is a function unit for performing CA configuration, and may be referred to as a configuration unit. Further, the RRC management unit 203 may include a function of specifying/managing bundling time and space in an ACK/NACK transmission method example 1 and a function of specifying/managing a PUCCH format in an ACK/NACK transmission method example 2 and association information between an ACK/NACK resource of CC and 5G subframe number, etc. It should be noted that the above functions may be included in a function unit other than the RRC management unit 203 in the base station eNB.

The scheduling unit 204 includes a function of performing scheduling for each cell for the user apparatus UE for which CA is performed, generating PDCCH allocation information, and causing the DL signal transmission unit 201 to transmit a PDCCH including the allocation information. Further, the scheduling unit 204 may include a function of determining whether the next data should be scheduled or retransmission data should be scheduled based on the ACK/NAC returned from the user apparatus UE. Further, the scheduling unit 204 includes a function of determining a dividing number of a soft buffer at the user apparatus UE, and transmitting the dividing number to the user apparatus UE via the DL signal transmission unit 201. It should be noted that the above function may be included in a function unit other than the scheduling unit 204.

The structure of the base station eNB illustrated in FIG. 8 may be entirely realized by a hardware circuit (e.g., one or more IC chips), or may be partially realized by a hardware circuit and the remaining part may be realized by a CPU and programs.

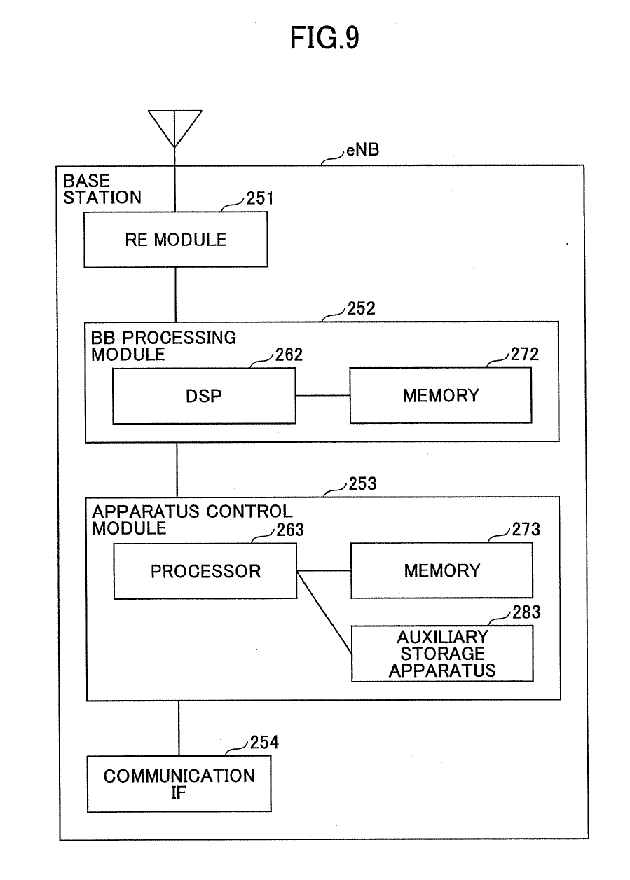

FIG. 9 is a drawing illustrating an example of a hardware (HW) configuration of the base station eNB. FIG. 9 illustrates a structure closer to an implementation example compared to FIG. 8. As illustrated in FIG. 9, the base station eNB includes an RE module 251 for performing a process related to a wireless signal, a BB processing module 252 for performing a baseband signal process, an apparatus control module 253 for performing a process of upper layers, etc., and a communication IF 254 as an interface for connecting to a network.

The RE module 251 generates a radio signal to be transmitted from an antenna by performing D/A conversion, modulation, frequency conversion, power amplification, etc., for a digital baseband signal received from the BB processing module 252. Further, the RE module 161 generates a digital baseband signal by performing frequency conversion, A/D conversion, demodulation, etc., for a received radio signal, and transmits the generated signal to the BB processing module 252. The RE module 251 has, for example, functions of a physical layer, etc., in the DL signal transmission unit 201 and the UL signal reception unit 202 illustrated in FIG. 8.

The BB processing module 252 performs a process of converting bidirectionally between an IP packet and a digital baseband signal. DSP 262 is a processor for performing signal processing in the BB processing module 252. A memory 272 is used as a work area of the DSP 252. The BB processing module 252 has, for example, functions of a layer 2, etc., in the DL signal transmission unit 201 and the UL signal reception unit 202 illustrated in FIG. 8, and includes the RRC management unit 203 and the scheduling unit 204. It should be noted that all or a part of functions of the RRC management unit 203 and the scheduling unit 204 may be included in the apparatus control module 253.

The apparatus control module 253 performs an IP layer protocol process, an OAM process, etc. A processor 263 performs processes performed by the apparatus control module 253. A memory 273 is used as a work area of the processor 263. An auxiliary storage apparatus 283 is, for example, a HDD, etc., and stores various types of configuration information items, etc., used for operations of the base station eNB.

<Configuration Example of DL Signal Reception Unit 102 of User Apparatus UE>

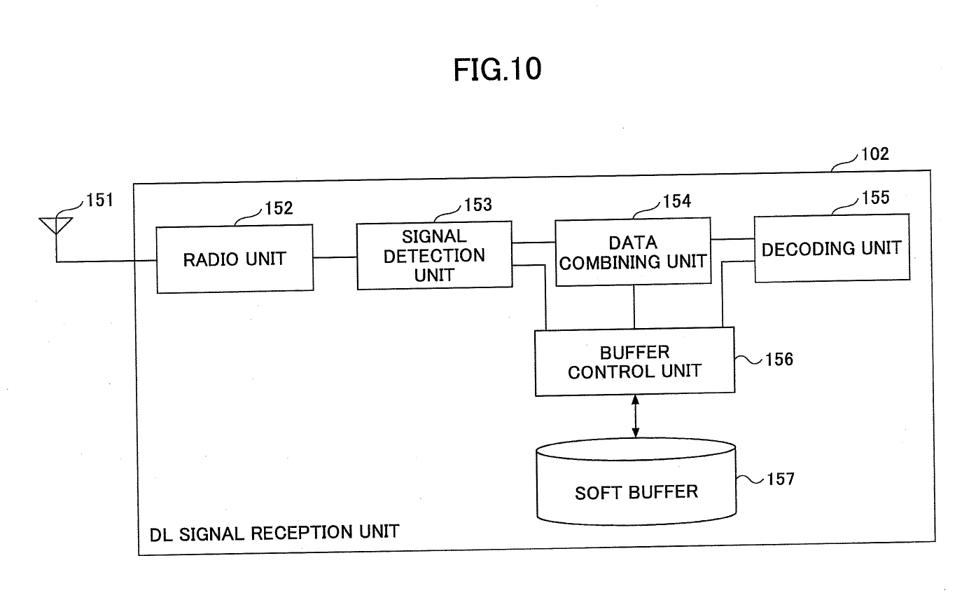

The soft buffer according to an embodiment is included in the DL signal reception unit 102 of the user apparatus UE, and thus, a configuration example of the DL signal reception unit 102 is illustrated in FIG. 10. It should be noted that FIG. 10 illustrates function units, of functions included in the DL signal reception unit 102, especially related to the soft buffer usage. For example, in the DL signal reception unit 102, a rate matching function unit, a circular buffer, etc., are also included.

As illustrated in FIG. 10, the DL signal reception unit 102 includes an antenna 151, a radio unit 152, a signal detection unit 153, a data combining unit 154, a decoding unit 155, a buffer control unit 156, and a soft buffer 157. It should be noted that the rate matching function unit, the circular buffer, etc., may be included in the signal detection unit 153 or the data combining unit 154.

The radio unit 152 performs a signal processing such as AD conversion for a signal received by the antenna 151. The signal detection unit 153 extracts an OFDM symbol sequence by applying an FFT process, etc., to a signal obtained by the radio unit 152, and obtains a bit sequence (soft decision data) by performing a decision process (e.g., soft decision process based on calculation of long likelihood ratio (LLR)). The decoding unit 155 obtains data (e.g., data of a transport block) by performing a decoding process of the soft decision data by using, for example, turbo decoding.

In the case where the decoding has failed, the soft decision data is stored in the soft buffer 157. The data combining unit 154 combines soft decision data retransmitted from a HARQ process and the soft decision data stored on the soft buffer 157, and transmits the combined data to the decoding unit 155, and the decoding unit 156 performs a decoding process. In the case where the decoding is successful, the soft decision data stored in the soft buffer 157 is removed.

It should be noted that the operation may be as follows: after soft decision data is generated, the generated soft decision data is stored in the soft buffer 157 (in the case where there is existing soft decision data, the existing soft decision data is read at this point); the soft decision data is removed in the case where the decoding of the soft decision data is successful, and the soft decision data is held as it is in the case where the decoding has failed.

The buffer control unit 156 performs a process of writing/reading the soft decision data to/from the soft buffer. Further, the buffer control unit 156 performs a process of dividing the soft buffer 157.

When CA is configured, for example, the data combining unit 154 and the decoding unit 155 are prepared for each cell (CC). Further, in the case where multiple HARQ processes are performed for respective cells (CCs), multiple divided soft buffers, which will be described later, may be prepared according to the number of the HARQ processes, or the divided soft buffer may be shared by the multiple HARQ processes.

(Process of Dividing Soft Buffer)

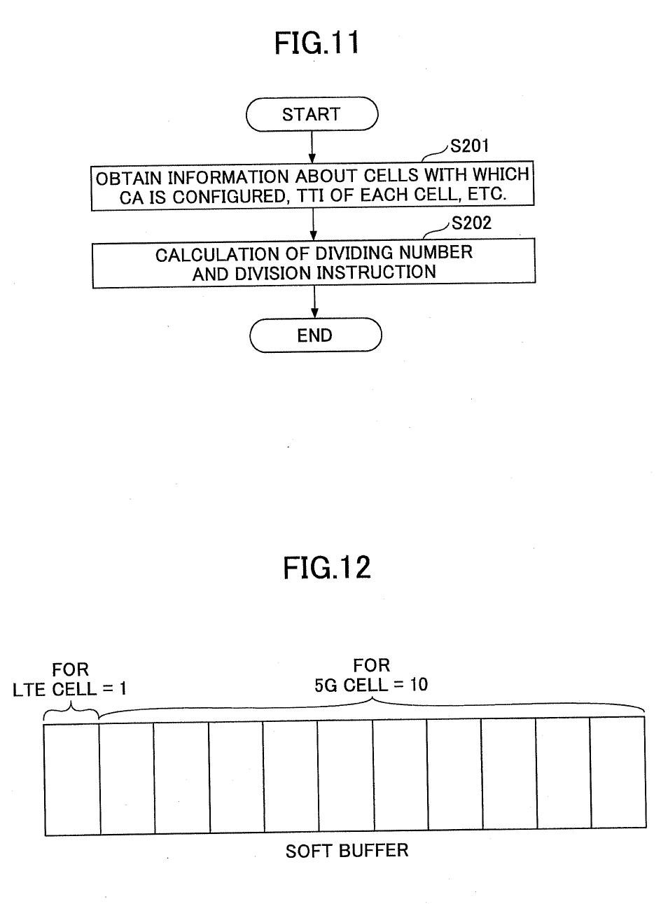

Referring to FIG. 11, a process of dividing the soft buffer 157 (hereinafter, referred to as soft buffer) performed by the buffer control unit 156 of the user apparatus UE will be described.

As a prerequisite of an operation illustrated in FIG. 11, it is assumed that CA has been configured for the base station eNB and the user apparatus UE with an LTE PCell and a 5G SCell. Further, the SCell has been activated by an activation command.

In step S201, the buffer control unit 156 of the user apparatus UE obtains information about CA-configured cells (TTI length, etc.,) and information about whether each cell (SCell) is in an active state, based on CA configuration information, state information (active state/non-active state) of CA-configured cells, etc. The CA configuration information and the state information of CA-configured cells are stored in a storage apparatus such as a memory of the user apparatus UE. The buffer control unit 156 of the user apparatus UE obtains the information by reading the information from the storage apparatus.

In step S202, the buffer control unit 156 of the user apparatus UE calculates the number of MAC PDUs which the user apparatus UE would receive in 1 LTE-TTI (corresponding to the number of transport blocks (TBs)) based on the information obtained in step S201, determines the calculated number as the number for dividing the soft buffer, and divides evenly the soft buffer with the dividing number.

For example, in the case where “LTE-TTI (e.g., 1 ms)=10×5G-TTI (e.g., 0.1 ms)”, the number of MAC PDUs which the user apparatus UE would receive in 1 LTE-TTI is 1 for LTE cell and 10 for 5G cell. In this case, the buffer control unit 156 determines that the dividing number of a soft buffer is 1+10=11. Further, for example, in the case where two 5G SCells are configured and are active, the dividing number can be calculated by 1+10+10.

In the case where the dividing number is 11, an example of a divided soft buffer is illustrated in FIG. 12. As illustrated in FIG. 12, the soft buffer is divided into 1 for LTE cell and 10 for 5G cell.

Depending on the transmission modes of the cells, there is a case where two TBs are received in a subframe (LTE subframe/5G subframe). In this case, calculated number for the cell may be doubled. For example, in the case where MIMO transmission mode is specified in LTE and 5G, 1×2 (for LTE cell)+10×2 (for 5G cell)=22 can be a dividing number. It should be noted that it is possible for the user apparatus UE to obtain information about transmission modes of the cells from transmission mode setting information (e.g., RRC signal) which the user apparatus UE receives from the base station eNB.

In a data reception operation, the buffer control unit 156 of the user apparatus UE stores the soft decision data items, which have been received during 1 LTE-TTI and the decoding of which has failed (there has been an error), in an area of the divided soft buffer. Further, the user apparatus UE transmits to the base station eNB an ACK/NACK for the DL data of LTE/5G received in an LTE-TTI by using an LTE subframe after a predetermined time (e.g., after 4 ms) of the LTE subframe in the LTE-TTI. Regarding the retransmitted data, the user apparatus UE combines the retransmitted data and the corresponding data stored in the soft buffer, and decodes the combined data.

In the above example, it is, but not limited to, the user apparatus UE that calculates the number for dividing a soft buffer. For example, it may be possible that the base station eNB determines the number for dividing the soft buffer at the user apparatus UE, transmits the determined dividing number to the user apparatus UE, and the user apparatus UE divides the soft buffer by using the received dividing number.

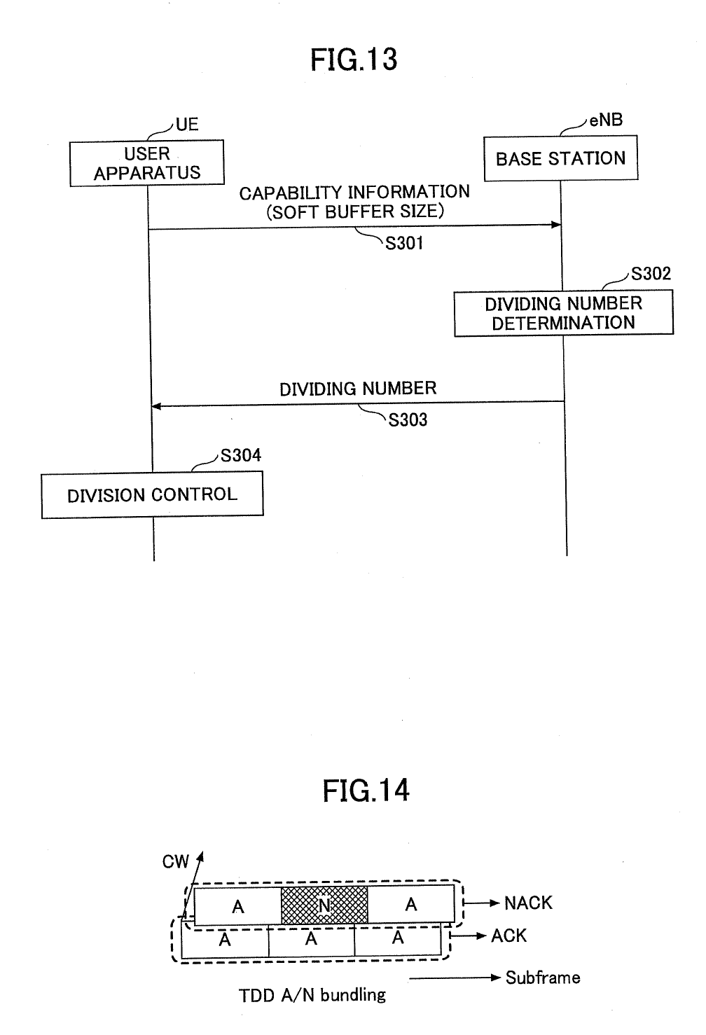

Referring to FIG. 13, an example of an operation of the above case will be described. As a prerequisite of an operation illustrated in FIG. 13, it is assumed that CA has been configured for the base station eNB and the user apparatus UE with an LTE PCell and a 5G SCell. Further, the SCell has been activated by an activation command.

In step S301, the user apparatus UE transmits as capability information a size of a soft buffer installed in the UE to the base station eNB. It should be noted that the user apparatus UE may transmit the capability information even in the case where it is the user apparatus UE that calculates the number for dividing the soft buffer.

In step S302, the base station eNB determines the number for dividing the soft buffer at the user apparatus UE. It is possible for the base station eNB to determine the dividing number, for example, by using the same method for determining the dividing number at the user apparatus UE as described above because the base station eNB has the configuration information, state information of the cells, etc., set in the user apparatus UE.

In step S303, the base station eNB transmits the determined dividing number to the user apparatus UE. The transmission may be performed by an RRC signal, a MAC signal, or a PHY signal.

In step S304, the user apparatus UE that has received the dividing number divides the soft buffer by using the buffer control unit 156, and performs HARQ control of DL data by using the divided soft buffer.

When determining the dividing number in step S302, the base station eNB may determine a value smaller than the calculated dividing number as the dividing number to be transmitted to the user apparatus UE so that the size of the soft buffer per MAC PDU becomes larger. Further, the base station eNB may determine whether the value smaller than the calculated dividing number should be used based on the size of the soft buffer transmitted as the capability information from the user apparatus UE. For example, the base station eNB may transmit a value smaller than the calculated dividing number in the case where a value obtained by dividing the size of the soft buffer transmitted from the user apparatus UE with the calculated dividing number is less than a predetermined value. The value smaller than the calculated dividing number can be determined in such a way that a value obtained by dividing the size of the soft buffer transmitted from the user apparatus UE with the “value smaller than the calculated dividing number” is equal to or greater than the predetermined value.

By using the “value smaller than the calculated dividing number” as the dividing number, the size of each of the divided areas is increased, the number of soft channel bits used for decoding is increased, and the decoding performance is improved.

There is a possibility that not all of the data items for LTE subframes/5G subframes can be stored in the soft buffer. In order to avoid such a possibility, for example, the base station eNB limits the LTE subframes/5G subframes to which the base station eNB allocates DL data for the user apparatus UE.

Further, it may be assumed that, in the case where the soft buffer is filled with received bits (soft decision data) and there is no empty area, the user apparatus UE does not perform a reception process in 5G subframes after the soft buffer is full. “Does not perform a reception process” means, for example, does not monitor a PDCCH in a 5G subframe in SCell.

Further, the user apparatus UE may determine whether the dividing number calculated by the user apparatus UE is used for dividing the soft buffer or the dividing number specified by the base station eNB is used for dividing the soft buffer based on an instruction received from the base station eNB via an RRC signal, etc.

By dividing the soft buffer by using the above described method, in LTE-5G CA, it is possible to avoid a situation in which the soft buffer for DL data received via the LTE subframe/5G subframe becomes insufficient even in the case where HARQ control is performed in which an ACK/NACK is transmitted by PUCCH of LTE.

As described above, in an embodiment, in LTE subframe, it is necessary to transmit multiple ACK/NACKs for DL data items received in multiple subframes of 5G. In the following, ACK/NACK transmission method examples 1 and 2 will be described.

As described below in detail, in ACK/NACK transmission method example 1, ACK/NACK transmission for the multiple DL data items received in the multiple 5G subframes is performed by using ACK/NACK bundling. In ACK/NACK transmission method example 2, ACK/NACK transmission for the multiple DL data items received in the multiple 5G subframes is performed by utilizing PUCCH format specified for CA with multiple CCs.

(ACK/NACK Transmission Method Example 1)

First, ACK/NACK transmission method example 1 will be described. When realizing LTE-5G CA, if a new PUCCH format for ACK/NACK is specified, then there is a possibility that complexity of UE/eNB may be wastefully increased. In order to solve the above problem, in ACK/NACK transmission method example 1, ACK/NACK bundling, which is an existing mechanism, is used for ACK/NACK transmission in LTE-5G CA. It should be noted that, although ACK/NACK bundling itself is an existing mechanism, an existing technique does not exist in which ACK/NACK bundling is applied to LTE-5G CA. By using ACK/NACK bundling, an existing PUCCH format can be used for ACK/NACK transmission in LTE-5G CA. Therefore, it is not necessary to specify a new format, and it is possible to avoid increased complexity due to an introduction of a new format.

Here, an overview of ACK/NACK bundling will be described. With respect to multiple data items (codewords) received in multiple subframes, multiple ACK/NACK bits are generated for each TTI (each subframe). In the case where ACK/NACK bundling is not used, basically, one ACK/NACK is transmitted by using one UL subframe. However, for example, in TDD, in the case where the number of DL subframes is greater than the number of UL subframes, it is necessary to transmit multiple ACK/NACKs for data received in multiple DL subframes by using a single UL subframe. In such a case, for example, ACK/NACK bundling is used. In ACK/NACK bundling, logical AND operation is applied to multiple ACK/NACK bits to obtain a single bit, and the single bit is transmitted as an ACK/NACK in a single UL subframe.

In FIG. 14, as an example, ACK/NACK bundling in TDD, Rel-8 (referred to as “A/N bundling” in the figure) is illustrated. As illustrated in FIG. 14, for example, a single ACK is obtained by bundling three ACKs, and a single NACK is obtained by bundling ACK/NACK/ACK.

In ACK/NACK transmission method example 1, ACK/NACKs for data received in downlink subframes in 5G cell are bundled and transmitted by LTE cell (PCell). It should be noted that an ACK/NACK for downlink data in an LTE cell can be transmitted in the same way as an existing technique.

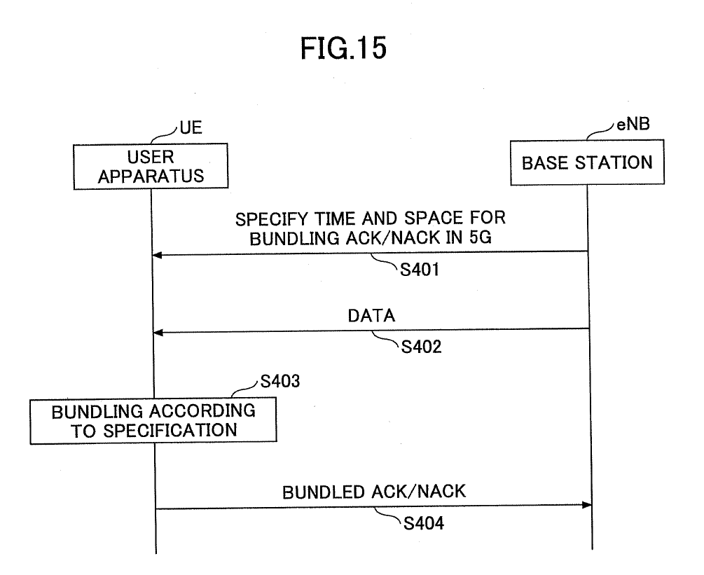

Referring to FIG. 15, an example of an operation in ACK/NACK transmission method example 1 will be described. As a prerequisite of an operation illustrated in FIG. 15, it is assumed that CA has been configured for the base station eNB and the user apparatus UE with an LTE PCell and a 5G SCell.

First, as illustrated in FIG. 15, the base station eNB specifies for the user apparatus UE time and space to which ACK/NACK bundling is applied in 5G (step S401). The base station eNB can specify the above time and space by using 5G subframe numbers. As an example, in the case where there are 5G subframes 0 through 9 in a time and space corresponding to an LTE subframe, the base station eNB transmits instruction information indicating “5G subframes 3-6 should be bundled” to the user apparatus UE.

With respect to ACK/NACK transmitted by a UL subframe of LTE, a single time and space (group) of bundling for 5G SCell may be specified, or multiple time and spaces (groups) may be specified. For example, it is possible for the base station eNB to transmit to the user apparatus UE instruction information indicating (“bundling 5G subframes 0-2 as a group A”, “bundling 5G subframes 3-6 as a group B”, and “bundling 5G subframes 7-9 as a group C”). The above groups may be referred to as bundling groups.

Transmission of the instruction information may be performed by an RRC signal, a MAC signal, or a PHY signal (PDCCH, etc.) Further, for example, bundling time and space may be specified by using an RRC signal for configuring SCell for the user apparatus UE (RRC connection reconfiguration). As described above, in the case where the bundling time and space is specified by using an RRC signal, the bundling time and space can be defined semi-statically.

Further, in the case where a MAC signal/PHY signal is used, the bundling time and space may be specified for each LTE subframe. In the case where the bundling time and space are specified for each LTE subframe, the bundling time and space can be changed dynamically (for each LTE subframe).

The user apparatus UE receives DL data items (TB) via a SCell in order (step S402). Here, for example, the user apparatus UE receives multiple DL data items by using multiple 5G subframes during a period of one LTE subframe.

The user apparatus UE generates ACK/NACKs of the DL data items received in step S402, and bundles ACK/NACKs of the DL data items according to the bundling instruction information received in step S401 (step S403).

In step S404, the user apparatus UE transmits the bundled ACK/NACK to the base station eNB by using a PUCCH of PCell. Here, for example, according to LTE specification, the user apparatus UE transmits the bundled ACK/NACK to the base station eNB in the LTE subframe four LTE subframes after the LTE subframe in which the DL data items are received.

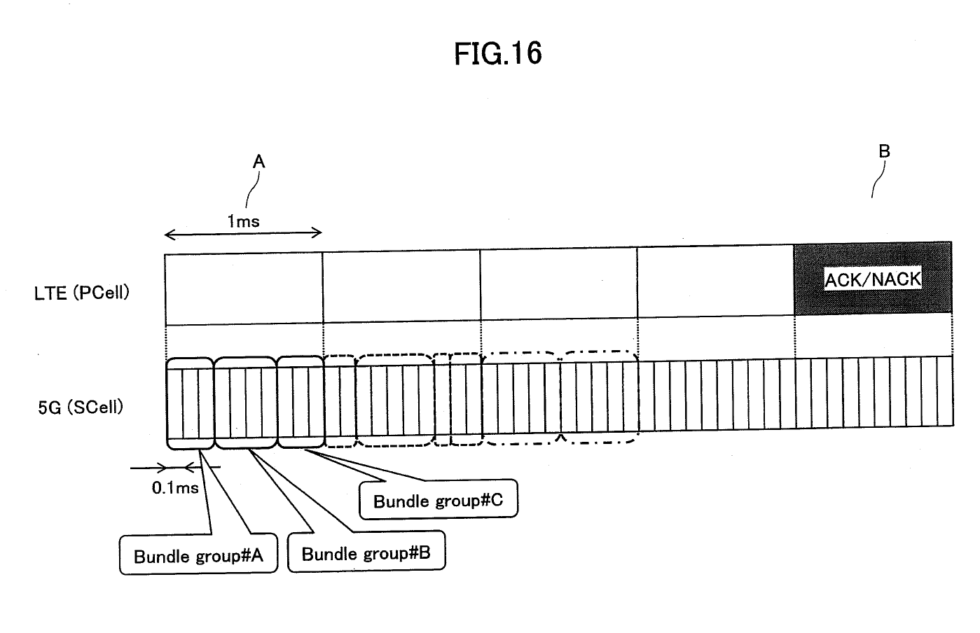

Referring to FIG. 16, an example of a bundling process will be described. In an example of FIG. 16, in an LTE subframe interval indicated by “A”, bundling time and space are configured in SCell as illustrated in the figure. In other words, as in the case described above, 5G subframes 0-2 are configured as a bundle group A, 5G subframes 3-6 are configured as a bundle group B, and 5G subframes 7-9 are configured as a bundle group C. It should be noted that, in an example illustrated in FIG. 16, in the next LTE subframe interval and in the following LTE subframe interval, bundle group configurations are different from the first LTE subframe interval.

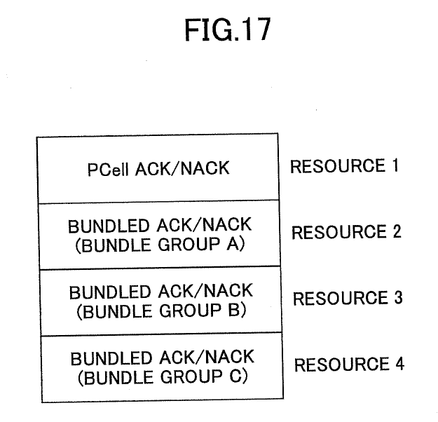

ACK/NACKs for the DL data items received in SCell in an LTE subframe interval indicated by “A” are bundled into bundle groups, and transmitted to the base station eNB via PCell PUCCH in an LTE subframe indicated by “B” four LTE subframes after “A”. An arrangement example of ACK/NACK of the bundle groups in radio resources of the PUCCH is illustrated in FIG. 17. In an example illustrated in FIG. 17, ACK/NACK for PCell DL data item is also included. As illustrated in FIG. 17, transmission is performed by using predetermined resources in PUCCH for ACK/NACK of corresponding cells/groups. As the predetermined resources in PUCCH, for example, resources for CCs specified for existing CA can be used. It should be noted that the “resources” for ACK/NACK transmission are, for example, a combination of time resources, frequency resources, and code resources.

In the case of FIG. 17, for example, the base station eNB understands the ACK/NACK mapped to the resource for CC#1 as PCell ACK/NACK, the ACK/NACK mapped to the resource for CC#2 as ACK/NACK of bundle group A, the ACK/NACK mapped to the resource for CC#3 as ACK/NACK of bundle group B, and the ACK/NACK mapped to the resource for CC#4 as ACK/NACK of bundle group C.

It should be noted that, by using a technique described in the ACK/NACK transmission method example 2, the base station eNB may transmit to the user apparatus UE association information between ACK/NACK resources for CC and ACK/NACK resources for bundle groups, and the user apparatus UE may transmit the bundled ACK/NACK by using the ACK/NACK resources according to the association information.

(ACK/NACK Transmission Method Example 2)

Next, ACK/NACK transmission method example 2 will be described. In existing LTE, PUCCH format for ACK/NACK transmission for maximum five carriers (CCs) is defined. On the other hand, in Rel-13, in CA, it is assumed that carriers equal to or more than 6 CCs (up to 32 CCs) are bundled, and it has been investigated that PUCCH format should be enhanced so that the enhanced PUCCH format can handle transmission of ACK/NACKs for data items transmitted by such many CCs. It should be noted that the above enhancement has to do with an existing PUCCH format, and is different from introducing a new PUCCH format for ACK/NACK transmission for 5G data.

In the ACK/NACK transmission method example 2, the PUCCH format in which an existing PUCCH format is enhanced for performing ACK/NACK transmission of six or more CCs is used. However, it is not required to use the enhanced format. It is possible to use the existing PUCCH format without enhancement (which format is capable of transmitting 5 CC ACK/NACKs) depending on the 5G TTI length.

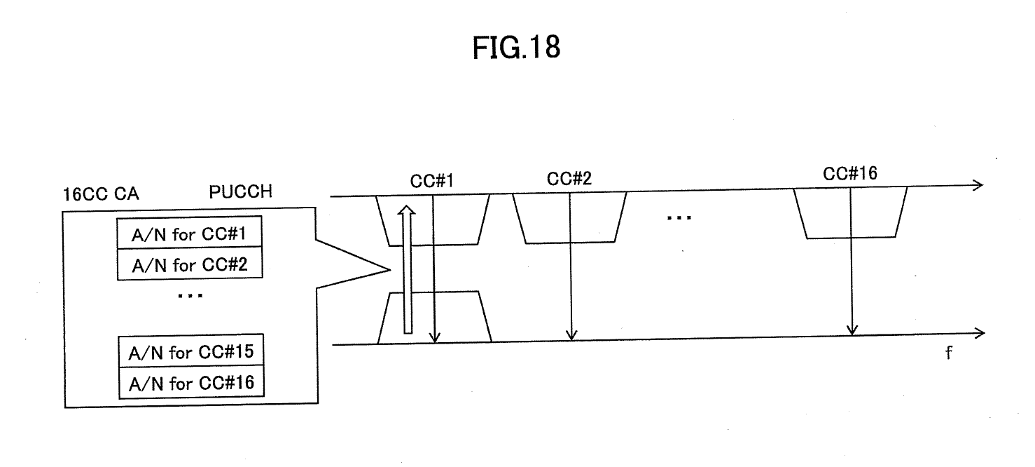

Referring to FIG. 18, a use example of the enhanced PUCCH format will be described. FIG. 18 illustrates an example of 16 CC CA in which CA is performed by bundling 16 CCs (a CC may be referred to as a cell). In FIG. 18, the cell including CC#1 is a PCell. As illustrated in FIG. 18, ACK/NACKs for the CCs are transmitted via the resources specified for the CCs in PUCCH. It should be noted that the specification of PUCCH format type which is capable of transmitting up to 16 CCs, the amount (the number of bits, etc.,) of resources which the user apparatus UE can use for transmitting ACK/NACKs by using the format, etc., are transmitted from the base station eNB to the user apparatus UE via a RRC signal, etc.

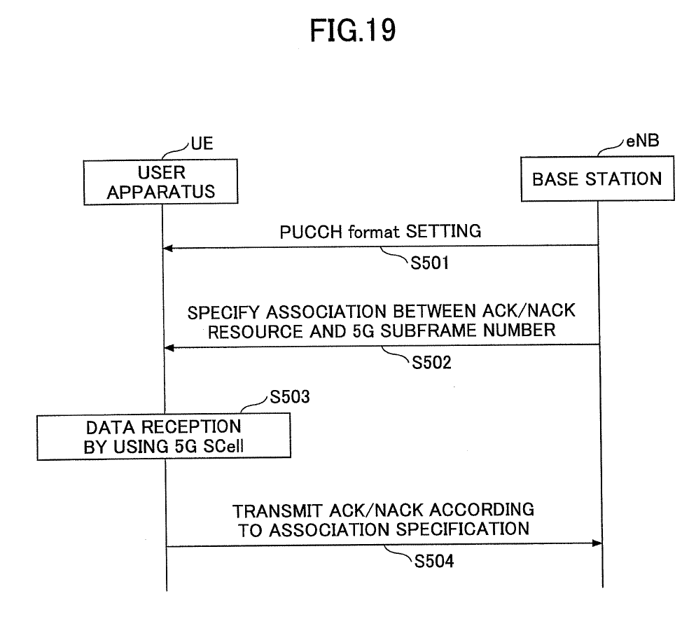

Referring to FIG. 19, an example of an operation in ACK/NACK transmission method example 2 will be described. As a prerequisite of an operation illustrated in FIG. 19, it is assumed that CA has been configured for the base station eNB and the user apparatus UE with an LTE PCell and a 5G SCell.

First, a PUCCH format configuration is transmitted from the base station eNB to the user apparatus UE via a RRC signal, etc. (step S501) The PUCCH format configured here is capable of transmitting ACK/NACKs for a lot of CCs such as 16 CCs or 32 CCs (16/32 CCs) (e.g., PUCCH in FIG. 18). The PUCCH format specification may also include resource amount specification for ACK/NACK transmission. In step S501, it may be assumed that 5G-SCell configuration and PUCCH format configuration are performed at the same time.

Next, the base station eNB associates, for the user apparatus UE, ACK/NACK resources for the CCs with 5G subframe numbers (5G-TTI numbers) in the PUCCH format configured in step S501. For example, the base station eNB transmits to the user apparatus UE instruction information for associating ACK/NACK resources for the CCs with resources for 5G ACK/NACK, such as “ACK/NACK resource for CC#1 in 16/32CC”=“ACK/NACK resource for 5G subframe#1 in 5G SCell”.

The transmission of the association instruction information may be performed by an RRC signal, a MAC signal, or a PHY signal. In the case where the transmission is performed by a RRC signal, the association instruction may be transmitted together with PUCCH format configuration in step S501. Further, in the case where a MAC signal or a PHY signal is used, the association between the ACK/NACK resources for the CCs and the ACK/NACK resource for 5G subframes may be changed for every LTE subframe.

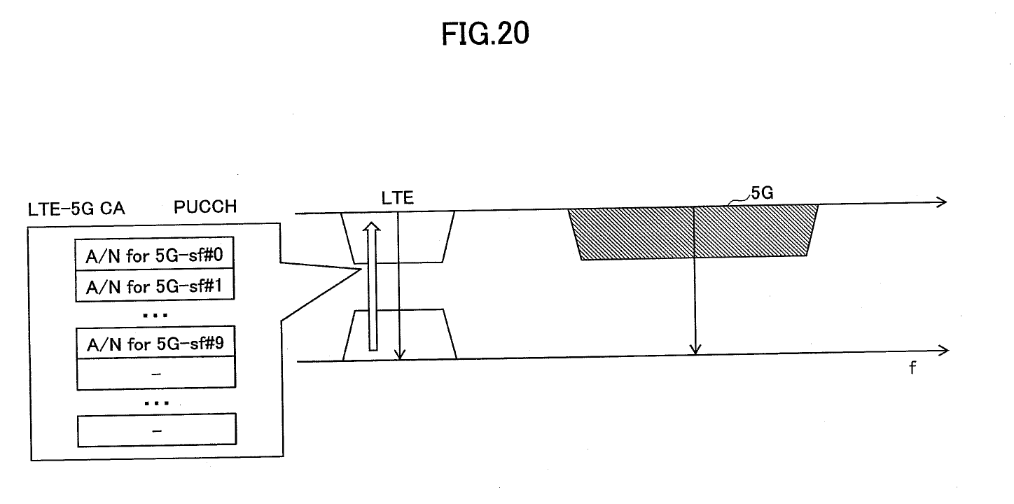

An example of the association is illustrated in FIG. 20. FIG. 20 illustrates a case where the PUCCH format illustrated in FIG. 18 is used. In the case of FIG. 20, ACK/NACK resources for CCs are associated with ACK/NACK resources for 5G subframes, for example, ACK/NACK resource for CC#1 is associated with ACK/NACK resource for 5G subframe #0, ACK/NACK resource for CC#2 is associated with ACK/NACK resource for 5G subframe #1, and so on.

In step S503 of FIG. 19, the user apparatus UE receives DL data (TB) from the base station eNB via SCell, and generates ACK/NACK for the DL data.

In step S504, according to the association instruction information received in step S502, the user apparatus UE transmits ACK/NACKs for the DL data items received via SCell by using PUCCH ACK/NACK resources. The ACK/NACK transmission is performed, for example, by using PUCCH of the LTE subframe four LTE subframes after the LTE subframe including the 5G subframe from which the DL data is received. This correspondence is the same as the case of FIG. 16 (“B” for “A”).

For example, in an example illustrated in FIG. 20, in the case where the user apparatus UE receives SCell DL data from 5G subframe #1 and 5G subframe #2, the user apparatus UE transmits ACK/NACK for the DL data by using ACK/NACK resources of PUCCH CC #2 and CC #3.

It is possible for the ACK/NACK transmission method example 1 and the ACK/NACK transmission method example 2 to be combined and performed. In other words, it is possible to transmit the bundled ACK/NACK by using PUCCH ACK/NACK resources for CCs described in the ACK/NACK transmission method example 2.

Further, in addition to a function related to soft buffer division, each of the user apparatus UE and the base station eNB may have both or any one of a function for performing a process described in the ACK/NACK transmission method example 1 and a function for performing a process described in the ACK/NACK transmission method example 2.

As described above, according to an embodiment, a user apparatus is provided. The user apparatus performs communications with a base station in a mobile communication system which includes a plurality of cells including a first cell and a second cell which uses a TTI length different from a TTI length of the first cell. The user apparatus includes a reception unit having a buffer configured to, in the case where decoding of downlink data received from the base station has failed, store the downlink data in the buffer, and combine the downlink data stored in the buffer and data retransmitted from the base station based on acknowledgment information for the downlink data, and decode the combined result; and a transmission unit configured to transmit the acknowledgment information for the downlink data to the base station. The reception unit includes a buffer control unit configured to divide the buffer with a dividing number based on the TTI length of the first cell and the TTI length of the second cell, and store the downlink data in a divided area of the buffer.

According to an embodiment, it is possible, in a mobile communication system which supports carrier aggregation including a plurality of cells with different TTI lengths, to appropriately divide a buffer used for controlling retransmission of downlink data in a user apparatus which performs the carrier aggregation.

In the case where the TTI length of the first cell is greater than the TTI length of the second cell, the buffer control unit may determine the dividing number based on the number of TTI lengths of the second cell included in the TTI length of the first cell. With the above arrangement, for example, even in the case where LTE-5G CA is performed, it is possible to avoid a situation in which the soft buffer as an example of the buffer becomes insufficient.

The buffer control unit may divide the buffer by using the dividing number received from the base station. With the above arrangement, it is possible for the user apparatus to use the dividing number determined by the base station, and thus, calculation load of the user apparatus can be reduced. Further, it becomes possible to perform flexible control with the base station's lead.

In the case where the buffer is full with the downlink data, it may be possible for the reception unit not to perform a process of receiving downlink data transmitted from the base station to the user apparatus. With the above arrangement, performing a wasteful reception process can be avoided.

It may be possible for the transmission unit to transmit to the base station a buffer amount included in the reception unit to the base station as capability information. With the above arrangement, it is possible for the base station to determine the dividing number or to perform scheduling by taking into account the buffer capability of the user apparatus. It should be noted that the transmission of the buffer amount is performed separately from the UE category transmission.

It may be possible that the reception unit receives the downlink data transmitted from the base station via the second cell, and generates acknowledgment information for the downlink data, and that the transmission unit bundles the multiple acknowledgment information items for the multiple downlink data items generated by the reception unit into a single acknowledgment information item, and transmits the bundled acknowledgment information item to the base station via the first cell. With the above arrangement, it is possible, in a mobile communication system which supports carrier aggregation including a plurality of cells with different TTI lengths, for a user apparatus which performs the carrier aggregation to appropriately transmit acknowledgment information for the downlink data to the base station.

It may be possible that the reception unit receives the downlink data transmitted from the base station via the second cell, and generates acknowledgment information for the downlink data, and that the transmission unit transmits the acknowledgment information generated by the reception unit to the base station via the first cell by using resources in the uplink control channel in which the resources for transmitting the acknowledgment information for the downlink data of multiple cells of the CA are predefined. With the above arrangement, it is possible, in a mobile communication system which supports carrier aggregation including a plurality of cells with different TTI lengths, for a user apparatus which performs the carrier aggregation to appropriately transmit acknowledgment information for the downlink data to the base station.

The user apparatus UE according to an embodiment may include a CPU (processor) and a memory, may be realized by having a program executed by the CPU, may be realized by hardware such as hardware circuitry in which the logic described in an embodiment is included, or may be realized by a mixture of a program and hardware.

The base station eNB according to an embodiment may include a CPU (processor) and a memory, may be realized by having a program executed by the CPU, may be realized by hardware such as hardware circuitry in which the logic described in an embodiment is included, or may be realized by a mixture of a program and hardware.

As described above, embodiments have been described. The disclosed invention is not limited to these embodiments, and a person skilled in the art would understand various variations, modifications, replacements, or the like. Specific examples of numerical values have been used for encouraging understanding of the present invention. These numeric values are merely examples and, unless otherwise noted, any appropriate values may be used. In the above description, partitioning of items is not essential to the present invention. Matters described in more than two items may be combined if necessary. Matters described in one item may be applied to matters described in another item (as long as they do not conflict). In a functional block diagram, boundaries of functional units or processing units do not necessarily correspond to physical boundaries of parts. Operations of multiple functional units may be physically performed in a single part, or operations of a single functional unit may be physically performed by multiple parts. For the sake of description convenience, the user apparatus and the base station have been described using functional block diagrams. These apparatuses may be implemented by hardware, by software, or by combination of both. The software which is executed by a processor included in a user apparatus according to an embodiment and the software which is executed by a processor included in a base station may be stored in a random access memory (RAM), a flash memory, a read-only memory (ROM), an EPROM, an EEPROM, a register, a hard disk drive (HDD), a removable disk, a CD-ROM, a database, a server, or any other appropriate recording medium. The present invention is not limited to the above embodiments and various variations, modifications, alternatives, replacements, etc., may be included in the present invention without departing from the spirit of the invention.

The present application is based on and claims the benefit of priority of Japanese Priority Application No. 2015-032341 filed on Feb. 20, 2015, the entire contents of which are hereby incorporated by reference.

1. A user apparatus which communicates with a base station in a mobile communication system which includes a plurality of cells including a first cell and a second cell which uses a TTI length different from a TTI length of the first cell, the user apparatus comprising:
a reception unit having a buffer configured to, in the case where decoding of downlink data received from the base station has failed, store the downlink data in the buffer, and combine the downlink data stored in the buffer and data retransmitted from the base station based on acknowledgment information for the downlink data, and decode the combined result; and
a transmission unit configured to transmit the acknowledgment information for the downlink data to the base station,
wherein the reception unit includes
a buffer control unit configured to divide the buffer with a dividing number based on the TTI length of the first cell and the TTI length of the second cell, and store the downlink data in a divided area of the buffer.

2. The user apparatus according to claim 1, wherein, in the case where the TTI length of the first cell is greater than the TTI length of the second cell, the buffer control unit determines the dividing number based on the number of TTI lengths of the second cell included in the TTI length of the first cell.

3. The user apparatus according to claim 1, wherein the buffer control unit divides the buffer by using the dividing number received from the base station.

4. The user apparatus according to claim 1, wherein, in the case where the buffer becomes full with the downlink data, the reception unit does not perform a process of receiving downlink data transmitted from the base station to the user apparatus.

5. The user apparatus according to claim 1, wherein the transmission unit transmits an amount of the buffer included in the reception unit to the base station as capability information.

6. The user apparatus according to claim 1, wherein the reception unit receives the downlink data transmitted from the base station via the second cell, and generates acknowledgment information items for the downlink data items, and the transmission unit bundles the acknowledgment information items for the downlink data items generated by the reception unit into a bundled acknowledgment information item, and transmits the bundled acknowledgment information item to the base station via the first cell.

7. The user apparatus according to claim 1, wherein the reception unit receives the downlink data transmitted from the base station via the second cell, and generates acknowledgment information items for the downlink data items, and the transmission unit transmits the acknowledgment information items generated by the reception unit to the base station via the first cell by using resources in an uplink control channel in which the resources for transmitting the acknowledgment information items for the downlink data items of the cells configured for carrier aggregation are predefined.

8. A buffer control method performed by a user apparatus which communicates with a base station in a mobile communication system which includes a plurality of cells including a first cell and a second cell which uses a TTI length different from a TTI length of the first cell, the buffer control method comprising:
in the case where decoding of downlink data received from the base station has failed, storing the downlink data in a buffer included in the user apparatus; combining the downlink data stored in the buffer and data retransmitted from the base station based on acknowledgment information for the downlink data; decoding the combined result; and
transmitting the acknowledgment information for the downlink data to the base station,
wherein in the receiving, the user apparatus divides the buffer with a dividing number based on the TTI length of the first cell and the TTI length of the second cell, and stores the downlink data in a divided area of the buffer.

9. The user apparatus according to claim 2, wherein the buffer control unit divides the buffer by using the dividing number received from the base station.

10. The user apparatus according to claim 2, wherein, in the case where the buffer becomes full with the downlink data, the reception unit does not perform a process of receiving downlink data transmitted from the base station to the user apparatus.

11. The user apparatus according to claim 2, wherein the transmission unit transmits an amount of the buffer included in the reception unit to the base station as capability information.

12. The user apparatus according to claim 2, wherein the reception unit receives the downlink data transmitted from the base station via the second cell, and generates acknowledgment information items for the downlink data items, and the transmission unit bundles the acknowledgment information items for the downlink data items generated by the reception unit into a bundled acknowledgment information item, and transmits the bundled acknowledgment information item to the base station via the first cell.

13. The user apparatus according to claim 2, wherein the reception unit receives the downlink data transmitted from the base station via the second cell, and generates acknowledgment information items for the downlink data items, and the transmission unit transmits the acknowledgment information items generated by the reception unit to the base station via the first cell by using resources in an uplink control channel in which the resources for transmitting the acknowledgment information items for the downlink data items of the cells configured for carrier aggregation are predefined.

14. The user apparatus according to claim 3, wherein, in the case where the buffer becomes full with the downlink data, the reception unit does not perform a process of receiving downlink data transmitted from the base station to the user apparatus.

15. The user apparatus according to claim 3, wherein the transmission unit transmits an amount of the buffer included in the reception unit to the base station as capability information.

16. The user apparatus according to claim 3, wherein the reception unit receives the downlink data transmitted from the base station via the second cell, and generates acknowledgment information items for the downlink data items, and the transmission unit bundles the acknowledgment information items for the downlink data items generated by the reception unit into a bundled acknowledgment information item, and transmits the bundled acknowledgment information item to the base station via the first cell.

17. The user apparatus according to claim 3, wherein the reception unit receives the downlink data transmitted from the base station via the second cell, and generates acknowledgment information items for the downlink data items, and the transmission unit transmits the acknowledgment information items generated by the reception unit to the base station via the first cell by using resources in an uplink control channel in which the resources for transmitting the acknowledgment information items for the downlink data items of the cells configured for carrier aggregation are predefined.

18. The user apparatus according to claim 4, wherein the transmission unit transmits an amount of the buffer included in the reception unit to the base station as capability information.

19. The user apparatus according to claim 4, wherein the reception unit receives the downlink data transmitted from the base station via the second cell, and generates acknowledgment information items for the downlink data items, and the transmission unit bundles the acknowledgment information items for the downlink data items generated by the reception unit into a bundled acknowledgment information item, and transmits the bundled acknowledgment information item to the base station via the first cell.

20. The user apparatus according to claim 4, wherein the reception unit receives the downlink data transmitted from the base station via the second cell, and generates acknowledgment information items for the downlink data items, and the transmission unit transmits the acknowledgment information items generated by the reception unit to the base station via the first cell by using resources in an uplink control channel in which the resources for transmitting the acknowledgment information items for the downlink data items of the cells configured for carrier aggregation are predefined.
